(19) United States
(12) Patent Application Publication
(10) Pub. No.: US 2024/0260025 A1
(43) Pub. Date: Aug. 1, 2024

(54) SYSTEMS AND METHODS FOR INDICATING SERVICE-BASED TIME PERIODICITY VALUES FOR SCHEDULING REQUEST OCCASIONS

(71) Applicant: Verizon Patent and Licensing Inc., Basking Ridge, NJ (US)

(72) Inventors: Susan Wu SANDERS, Bridgewater, NJ (US); Jin YANG, Orinda, CA (US); Xin WANG, Morris Plains, NJ (US)

(73) Assignee: Verizon Patent and Licensing Inc., Basking Ridge, NJ (US)

(21) Appl. No.: 18/160,076

(22) Filed: Jan. 26, 2023

(51) Int. Cl. H04W 72/1263; H04W 72/11; H04W 72/20; H04W 72/54

(52) U.S. Cl. CPC H04W 72/1263; H04W 72/11; H04W 72/20; H04W 72/54

(57) ABSTRACT

In some implementations, a network node may transmit, to a user equipment (UE), a configuration that indicates a default time periodicity value for a scheduling request (SR) occasion. The network node may identify a service provided by the network node. The network node may transmit, to the UE, a reconfiguration message that indicates a modified time periodicity value for the SR occasion, the modified time periodicity value being different than the default time periodicity value based on the service provided by the network node. The network node may receive, from the UE, an SR based on the modified time periodicity value for the SR occasion.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications. “Downlink” (or “DL”) refers to a communication link from the network node to the UE, and “uplink” (or “UL”) refers to a communication link from the UE to the network node.

### BRIEF DESCRIPTION OF THE DRAWINGS

FIG. 1 is a diagram of an example associated with indicating service-based time periodicity values for scheduling request (SR) occasions.

FIG. 2 is a diagram of an example associated with different time periodicity values for SR occasions.

FIG. 3 is a diagram of an example associated with monitoring a loading associated with a physical uplink control channel (PUCCH).

FIG. 4 is a diagram of an example associated with indicating service-based time periodicity values for SR occasions.

FIG. 5 is a diagram of an example associated with transmitting an SR based on a selected time periodicity value for an SR occasion.

FIG. 6 is a diagram of an example associated with selecting a time periodicity value for an SR occasion based on application data.

FIG. 7 is a diagram of an example environment in which systems and/or methods described herein may be implemented.

FIG. 8 is a diagram of example components of one or more devices of FIG. 7.

FIG. 9 is a flowchart of an example process associated with indicating service-based time periodicity values for SR occasions.

### DETAILED DESCRIPTION OF EXAMPLE EMBODIMENTS

The following detailed description of example implementations refers to the accompanying drawings. The same reference numbers in different drawings may identify the same or similar elements.

A Fifth Generation (5G) New Radio (NR) system may provide a low latency service, such as a critical Internet of Things (IoT) service. Certain 5G NR features may be designed to further reduce latency, but may impact a network capacity. For example, an NR uplink configured grant may be designed to lower latency, but a periodic pattern associated with the NR uplink configured grant may have a relatively large impact on an uplink capacity depending on a grant size and a number of UEs configured in a serving cell. As another example, an NR uplink pre-scheduling may provide low latency without being tied to a specific periodicity (e.g., increased flexibility), but may increase a utilization of a downlink physical downlink control channel (PDCCH) and thus only a limited number of UEs may be supported. The NR uplink configured grant and the NR uplink pre-scheduling may be enabled for a limited number of UEs for a predetermined period of time in view of a resource utilization intensity associated with the NR uplink configured grant and the NR uplink pre-scheduling. When the predetermined period of time expires for the limited number of UEs, or when a greater number of UEs require a low latency service, the network may need to rely on other mechanisms.

A UE may use a scheduling request (SR) occasion to transmit an SR to a network node. When the UE has data to be transmitted, the UE may wait for a next available SR occasion to transmit the SR. A plurality of periodic SR occasions may be available to the UE when the UE is in a radio resource control (RRC) connected mode. A shorter periodicity for the SR occasions may provide lower latency, but may utilize greater physical uplink control channel (PUCCH) resources. A longer periodicity for the SR occasions may be associated with a higher latency, but may utilize fewer PUCCH resources.

However, the periodicity for the SR occasions may only be based on a frequency range associated with the network node. For example, for a first frequency range (FR1), the SR occasions may be associated with a first fixed time periodicity value, and for a second frequency range (FR2), the SR occasions may be associated with a second fixed time periodicity value. When such a static time periodicity value is predefined for the SR occasions, in some cases, the number of available SR occasions may be greater than needed, or the number of available SR occasions may be fewer than needed. When the number of available SR occasions are greater than needed, a shorter periodicity for SR occasions may be present, thereby result in the utilization of greater uplink PUCCH resources. When the number of available SR occasions are fewer than needed, a longer periodicity for SR occasions may be present, thereby resulting in a higher latency.

In some implementations described in the present disclosure, service-aware periodic SR occasions may be implemented, which may support low latency service with a shorter SR occasion periodicity via quality of service (QoS) settings (e.g., service awareness). Depending on a service provided by a network node, the periodicity for the SR occasions may be adjusted. The service may be associated with a QoS class identifier (QCI) or a 5G QoS identifier (5QI). For example, the service may be a low latency service. The service may be an enhanced mobile broadband (eMBB) service, which may be associated with a default service. The service may be a deprioritized service, which may be associated with a long latency service. The low latency service may be associated with a short SR occasion periodicity, the eMBB service may be associated with a default (or normal) SR occasion periodicity, and the deprioritized service may be associated with a long SR occasion periodicity. As a result, the SR occasion periodicity may be optimized depending on the type of service, thereby leading to a more efficient utilization of PUCCH resources.

In some implementations, by implementing the service-aware periodic SR occasions, the periodicity of the SR occasions may be tied to the type of service provided by the network node, which may improve latency and a PUCCH resource utilization. When the service is associated with a low latency, an applicable SR occasion periodicity may be selected. When the service is associated with a default latency or a long latency, an applicable SR occasion periodicity may be selected. As a result, when the low latency service is employed, the UE may avoid using the long SR occasion periodicity and the default SR occasion periodicity, which may result in the proper amount of PUCCH resources being used for the low latency service. When the eMBB service is employed, the UE may avoid using the long SR occasion periodicity and the short SR occasion periodicity, which may result in the proper amount of PUCCH resources being used for the eMBB service. When the deprioritized service is employed, the UE may avoid using the short SR occasion periodicity and the default SR occasion periodicity, which may result in the proper amount of PUCCH resources being used for the deprioritized service. By avoiding using an excessive amount of PUCCH resources, in relation to the service that is being provided to the UE, an overall performance of the UE may be improved.

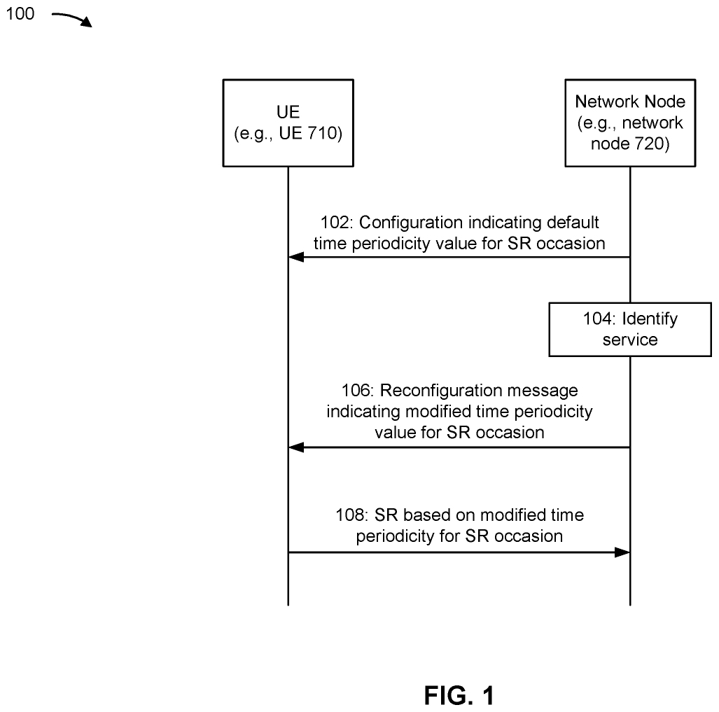

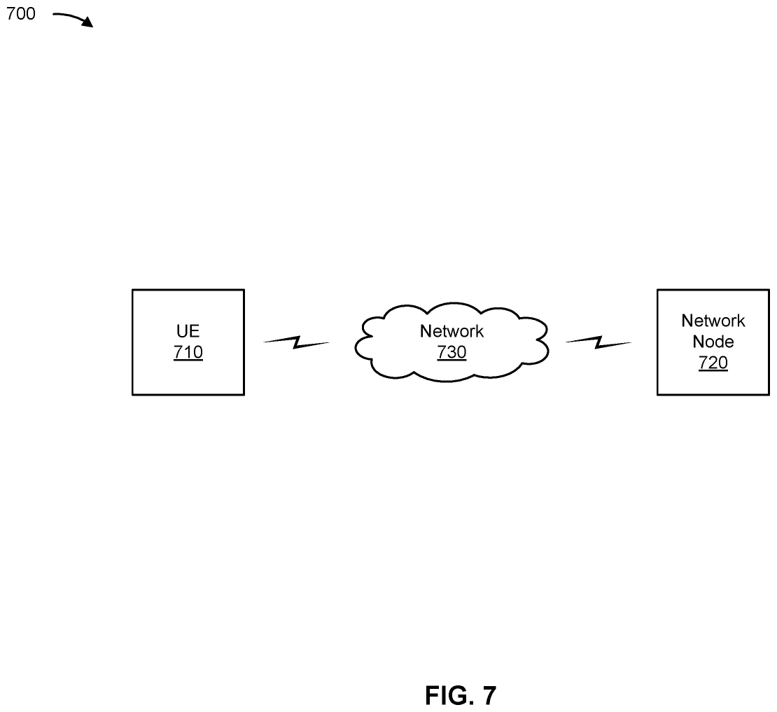

FIG. 1 is a diagram of an example 100 associated with indicating service-based time periodicity values for SR occasions. As shown in FIG. 1, example 100 includes a UE (e.g., UE 710 of FIG. 7) and a network node (e.g., network node 720 of FIG. 7).

As shown by reference number 102, the network node may transmit, to the UE, a configuration that indicates a default time periodicity value for an SR occasion. The configuration may be an RRC configuration. The default time periodicity value for the SR occasion (or SR occasions) may be a default SR occasion periodicity. The default time periodicity value for the SR occasion may be associated with a default latency service (or a normal latency service), such as an eMBB service. The default time periodicity value for the SR occasion may be associated with a frequency range (e.g., FR1 or FR2) and a loading associated with a PUCCH. The loading (e.g., normal or high) may indicate a relative utilization of PUCCH resources. For example, when a usage of PUCCH resources satisfies a first threshold, the loading associated with the PUCCH may be normal. When the usage of PUCCH resources satisfies a second threshold, the loading associated with the PUCCH may be high. The default time periodicity value for the SR occasion may be based on the frequency range and the loading associated with the PUCCH.

As shown by reference number 104, the network node may identify a service provided by the network node. The service may be the default latency service, a low latency service, or a high latency service (e.g., a deprioritized service). The network node may determine whether the low latency service is enabled. The network node may determine whether the high latency service is enabled (e.g., whether the service provided by the network node is deprioritized). The service may be associated with a QCI or a 5QI, which may indicate a type of service (e.g., default latency service, low latency service, or high latency service). In other words, the QCI or the 5QI may indicate the eMBB service, the low latency service, or the deprioritized service.

In some implementations, the service may be associated with a service level provided to the UE (e.g., a service level of the service provided to the UE). The service provided to the UE may refer to the service level (e.g., the low latency service or the deprioritized service) provided to the UE. As an example, multiple different services may be low latency services.

As shown by reference number 106, the network node may transmit, to the UE, a reconfiguration message that indicates a modified time periodicity value for the SR occasion. The reconfiguration message may be an RRC reconfiguration message. The modified time periodicity value for the SR occasion (or SR occasions) may be a modified SR occasion periodicity. The modified time periodicity value for the SR occasion may be different than the default time periodicity value based on the service provided by the network node. The modified time periodicity value for the SR occasion may be based on the frequency range and the loading associated with the PUCCH.

In some implementations, when the service is the low latency service, the modified time periodicity value for the SR occasion may be less than the default time periodicity value for the SR occasion. When the network node determines that the low latency service has been disabled, the configuration indicating the default time periodicity value for the SR occasion may be applied. In other words, the modified time periodicity value for the SR occasion may no longer be applicable after the low latency service has been disabled. The network node may retransmit, to the UE, the reconfiguration message indicating the default time periodicity value for the SR occasion.

In some implementations, when the service is the deprioritized service, the modified time periodicity value for the SR occasion may be greater than the default time periodicity value for the SR occasion. When the network node determines that the deprioritized service has been disabled, the configuration indicating the default time periodicity value for the SR occasion may be applied. In other words, the modified time periodicity value for the SR occasion may no longer be applicable after the deprioritized service has been disabled. The network node may retransmit, to the UE, the reconfiguration message indicating the default time periodicity value for the SR occasion.

In some implementations, the network node may monitor the loading associated with the PUCCH, where the default time periodicity value for the SR occasion and the modified time periodicity value for the SR occasion may be based on the loading associated with the PUCCH. When the network node detects a change in the loading associated with the PUCCH (e.g., a change from a normal PUCCH loading to a high PUCCH loading, or vice versa), the network node may adjust the default time periodicity value for the SR occasion or the modified time periodicity value for the SR occasion.

As shown by reference number 108, the network node may receive, from the UE, an SR based on the modified time periodicity value for the SR occasion. In other words, the UE may transmit the SR based on the modified time periodicity value for the SR occasion, which may be indicated by the network node to the UE. When the low latency service is being provided to the UE, the UE may only need to wait a relatively short amount of time until a next SR occasion because the modified SR occasion periodicity will be relatively short.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

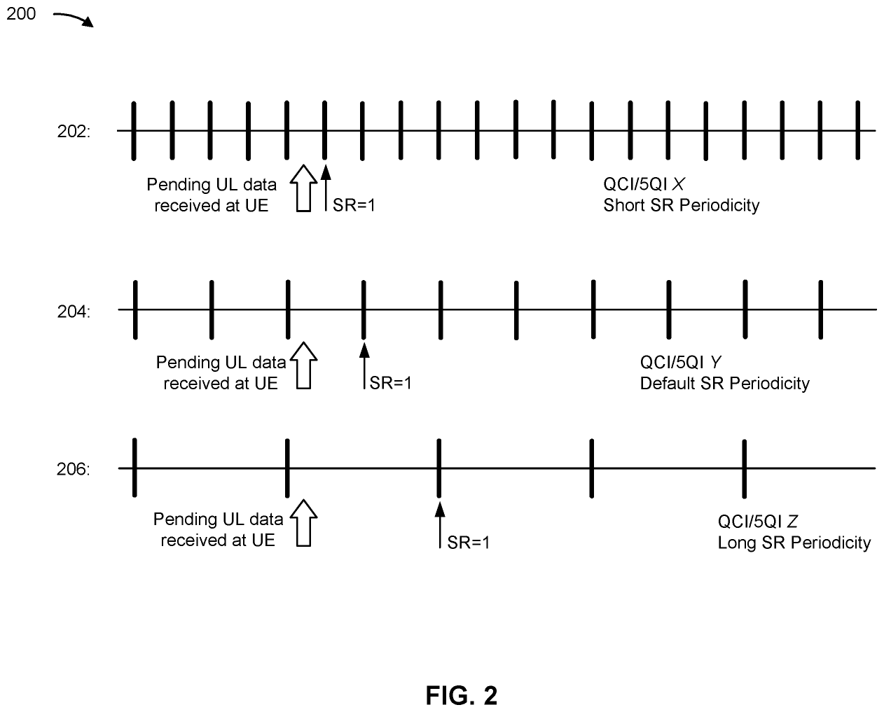

FIG. 2 is a diagram of an example 200 associated with different time periodicity values for SR occasions.

In some implementations, a PUCCH may be associated with a normal loading. For a low latency service (e.g., a QCI or slice associated with the low latency service), a network node may configure a short SR occasion periodicity (e.g., about 5 ms on FR1 and about 1 ms on FR2). For a default latency service (e.g., a QCI or slice associated with an eMBB service), the network node may configure a default SR occasion periodicity (e.g., about 10 ms on FR1 and about 5 ms on FR2). For other services including long latency services (e.g., a QCI or slice associated with a deprioritized service), the network node may configure a long SR occasion periodicity (e.g., about 20 ms on FR1 and about 10 ms on FR2). In some implementations, a PUCCH may be associated with a high loading. In this case, the network node may increase the default SR occasion periodicity for the default latency service. For example, the network node may increase the default SR occasion periodicity from about 10 milliseconds (ms) to about 20 ms on FR1 for the default latency service. Thus, the periodicity of the SR occasions may be configured based on the QCI and the loading associated with the PUCCH.

As shown by reference number 202, a periodic SR occasion may be associated with the short SR occasion periodicity, which may be associated with a first QCI/5QI value. When pending uplink data is received at a UE, a next SR occasion associated with the short SR occasion periodicity may be used by the UE to transmit an SR to the network node. As shown by reference number 204, a periodic SR occasion may be associated with the default SR occasion periodicity, which may be associated with a second QCI/5QI value. When pending uplink data is received at the UE, a next SR occasion associated with the default SR occasion periodicity may be used by the UE to transmit an SR to the network node. As shown by reference number 206, a periodic SR occasion may be associated with the long SR occasion periodicity, which may be associated with a third QCI/5QI value. When pending uplink data is received at the UE, a next SR occasion associated with the long SR occasion periodicity may be used by the UE to transmit an SR to the network node.

As indicated above, FIG. 2 is provided as an example. Other examples may differ from what is described with regard to FIG. 2.

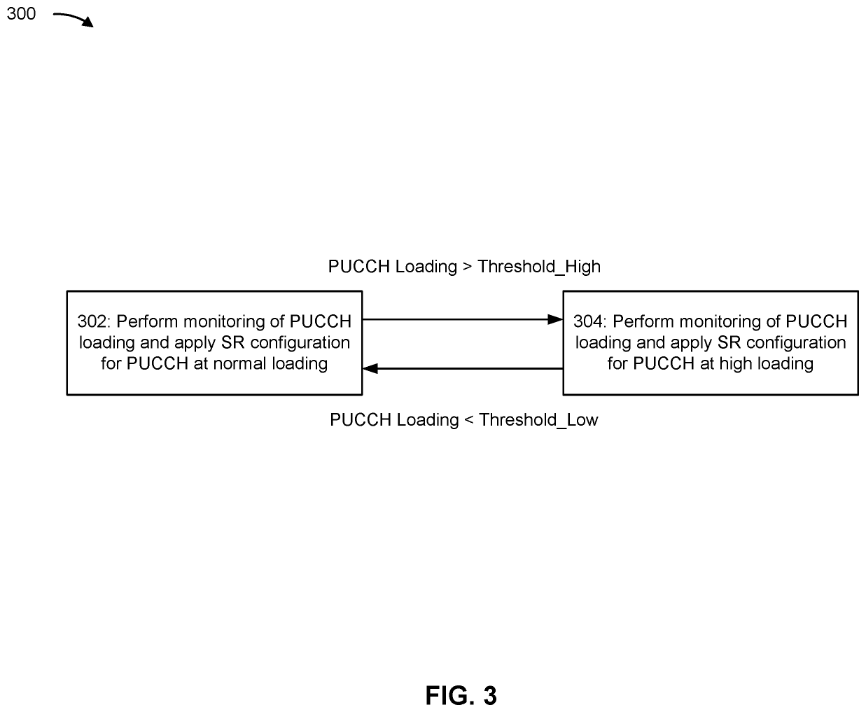

FIG. 3 is a diagram of an example 300 associated with monitoring a loading associated with a PUCCH.

As shown by reference number 302, a network node may perform a monitoring of a PUCCH loading. The network node may perform a continuous monitoring of the PUCCH loading. The network node may determine that the PUCCH is associated with a normal loading. In this case, the network node may apply an SR configuration associated with the normal loading. The SR configuration may define an SR occasion periodicity that is associated with the normal loading. The SR occasion periodicity that is associated with the normal loading may be for a low latency service, a default latency service (e.g., an eMBB service), or a long latency service (e.g., a deprioritized service).

In some implementations, the network node may determine whether the PUCCH loading satisfies a first threshold (e.g., whether the PUCCH loading is greater than a threshold high value). The network node may determine that the PUCCH loading is associated with a high loading, which may be based on the PUCCH loading satisfying the first threshold.

As shown by reference number 304, the network node may perform the monitoring of the PUCCH loading. The network node may perform the continuous monitoring of the PUCCH loading. The network node may determine that the PUCCH is associated with the high loading. In this case, the network node may apply an SR configuration associated with the high loading. The SR configuration may define an SR occasion periodicity that is associated with the high loading. The SR occasion periodicity that is associated with the high loading may be for the low latency service, the default latency service (e.g., an eMBB service), or the long latency service (e.g., the deprioritized service). When the PUCCH is associated with the high loading, the network node may increase a default SR occasion periodicity associated with the default latency service.

In some implementations, the network node may determine whether the PUCCH loading satisfies a second threshold (e.g., whether the PUCCH loading is less than a threshold low value). The network node may determine that the PUCCH loading is associated with the normal loading, which may be based on the PUCCH loading satisfying the second threshold. In this case, the network node may revert back to applying the SR configuration associated with the normal loading.

As indicated above, FIG. 3 is provided as an example. Other examples may differ from what is described with regard to FIG. 3.

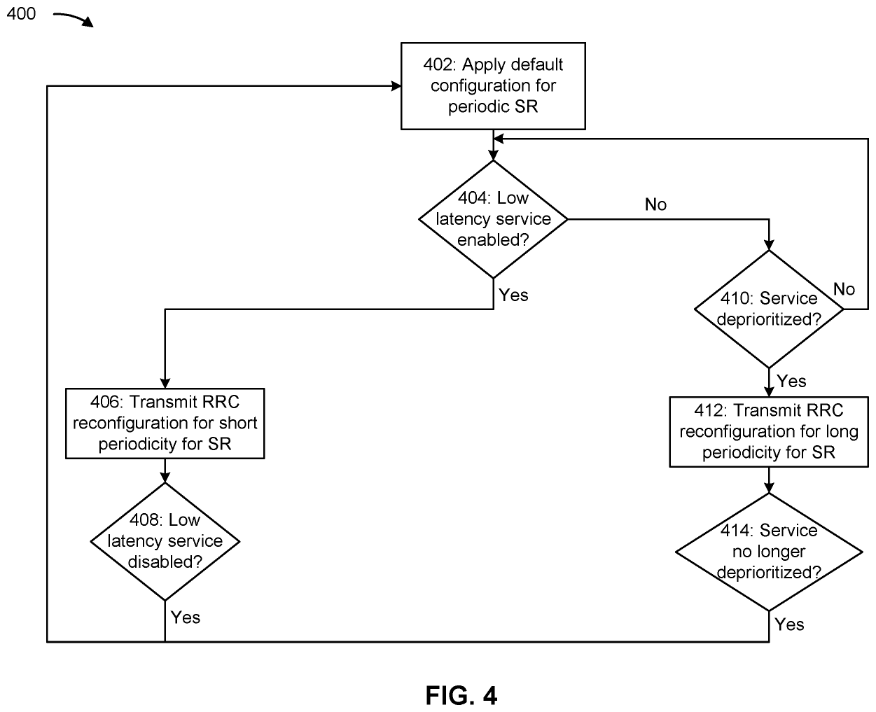

FIG. 4 is a diagram of an example 400 associated with indicating service-based time periodicity values for SR occasions.

As shown by reference number 402, a network node may apply a configuration for a default SR occasion periodicity. The configuration may be applicable to a default latency service, such as an eMBB service. As an example, the default SR occasion periodicity may be about 10 ms on FR1 and about 5 ms on FR2 for a normal PUCCH loading, and the default SR occasion periodicity may be about 20 ms on FR1 and about 10 ms on FR2 for a high PUCCH loading.

As shown by reference number 404, the network node may determine whether a low latency service is enabled. In other words, the network node may determine whether the low latency service is being provided by the network node to the UE.

As shown by reference number 406, when the low latency service is enabled, the network node may transmit, to the UE, an RRC reconfiguration message for a short SR occasion periodicity. As an example, the short SR occasion periodicity may be about 5 ms on FR1 and about 1 ms on FR2 for a normal PUCCH loading. The UE may follow the short SR occasion periodicity indicated by the network node. As shown by reference number 408, the network node may detect when the low latency service has been disabled. In this case, the network node may revert back to applying the configuration for the default SR occasion periodicity.

As shown by reference number 410, when the low latency service is not enabled, the network node may determine whether a deprioritized service is being provided by the network node. As shown by reference number 412, when the deprioritized service is being provided by the network node, the network node may transmit, to the UE, an RRC reconfiguration message for a long SR occasion periodicity. As an example, the long SR occasion periodicity may be about 20 ms on FR1 and about 10 ms on FR2 for a normal PUCCH loading. The UE may follow the long SR occasion periodicity indicated by the network node. As shown by reference number 414, the network node may detect when the deprioritized service has been disabled. In this case, the network node may revert back to applying the configuration for the default SR occasion periodicity.

In some implementations, the network node may determine whether or not to transmit the RRC configuration for the short SR occasion periodicity or the long SR occasion periodicity, depending on whether the low latency service is enabled and/or whether the deprioritized service is being provided by the network. The UE may receive the RRC configuration from the network node, and the UE may be configured to apply the short SR occasion periodicity or the long SR occasion periodicity indicated in the RRC configuration when transmitting an SR to the network node.

As indicated above, FIG. 4 is provided as an example. Other examples may differ from what is described with regard to FIG. 4.

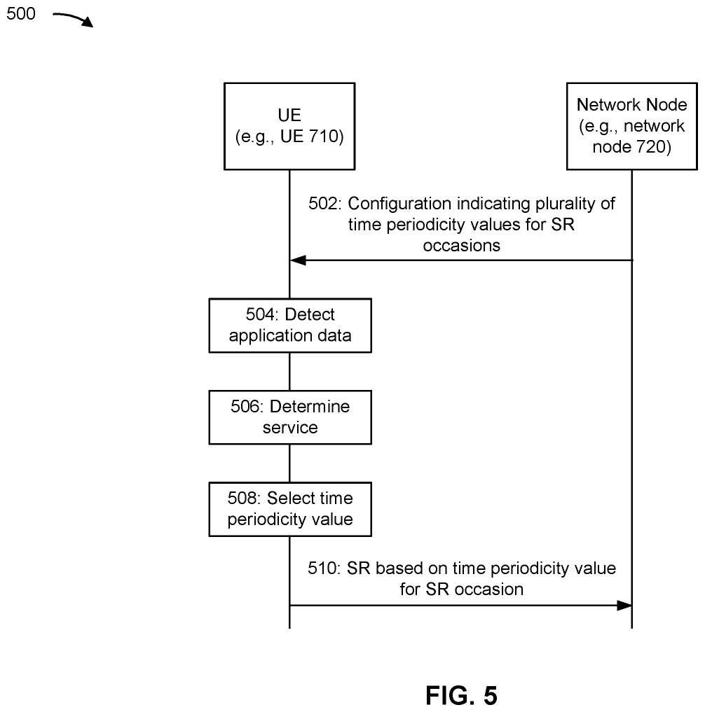

FIG. 5 is a diagram of an example 500 associated with transmitting an SR based on a selected time periodicity value for an SR occasion. As shown in FIG. 5, example 500 includes a UE (e.g., UE 710 of FIG. 7) and a network node (e.g., network node 720 of FIG. 7).

As shown by reference number 502, the UE may receive, from the network node, a configuration that indicates a plurality of time periodicity values for SR occasions. The configuration may be an RRC configuration or an RRC reconfiguration message. The plurality of time periodicity values for SR occasions may include a first time periodicity value associated with a default latency service (e.g., an eMBB bearer or an eMBB service). The first time periodicity value may be associated with a default SR occasion periodicity. The plurality of time periodicity values for SR occasions may include a second time periodicity value associated with a low latency service (e.g., a low latency bearer). The second time periodicity value may be associated with a short SR occasion periodicity. The plurality of time periodicity values for SR occasions may include a third time periodicity value associated with a high latency service (e.g., a deprioritized bearer or a deprioritized service). The third time periodicity value may be associated with a long SR occasion periodicity.

As shown by reference number 504, the UE may detect application data received from an upper layer of the UE. The UE may receive the application data from the upper layer, and the UE may need to transmit an SR in order to transmit the application data.

As shown by reference number 506, the UE may determine a service associated with the application data. The service associated with the application data may be the default latency service, the low latency service, or the high latency service. The service may be associated with a QCI or a 5QI, which may indicate a type of service (e.g., default latency service, low latency service, or high latency service). In other words, the QCI or the 5QI may indicate the eMBB service, the low latency service, or the deprioritized service. The service associated with the application data may be associated with a service level provided to the UE.

As shown by reference number 508, the UE may select a time periodicity value for an SR occasion from the plurality of time periodicity values based on the service associated with the application data. For example, the UE may select the first time periodicity value when the service associated with the application data is the default latency service. The UE may select the second time periodicity value when the service associated with the application data is the low latency service. The UE may select the third time periodicity value when the service associated with the application data is the high latency service.

As shown by reference number 510, the UE may transmit, to the network node, an SR based on the time periodicity value for the SR occasion. The UE may transmit the SR based on the time periodicity value for the SR occasion, which may be selected by the UE based on the service associated with the application data. The UE may transmit the SR, and in response, the network node may indicate a scheduling resource to be used by the UE. The UE may transmit, to the network node, the application data using the scheduling resource.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

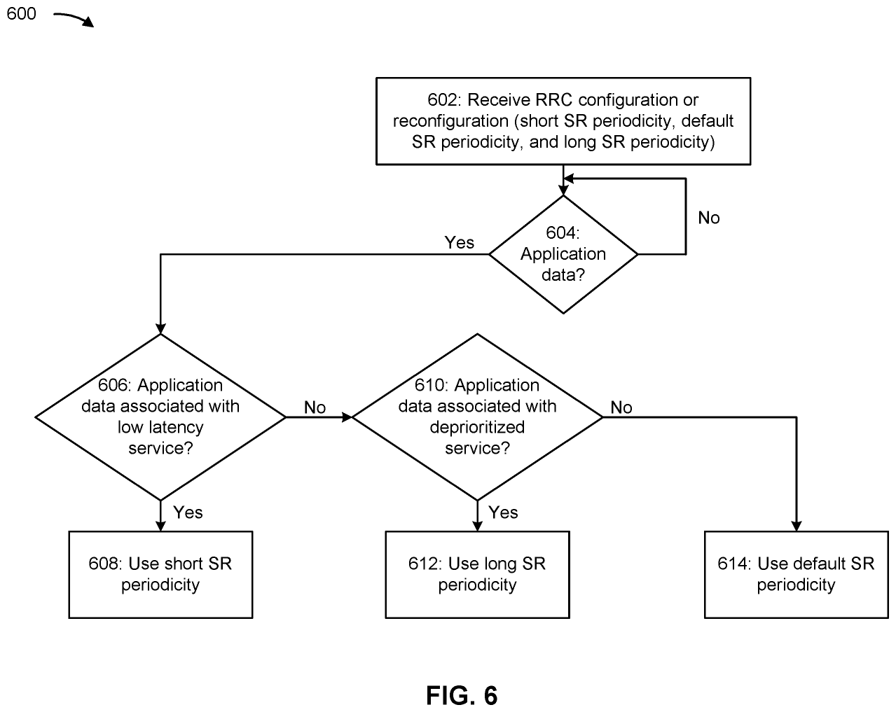

FIG. 6 is a diagram of an example 600 associated with selecting a time periodicity value for an SR occasion based on application data.

As shown by reference number 602, the network node may transmit an RRC message, such as an RRC configuration or an RRC reconfiguration message, to the UE. The RRC message may configure a default SR occasion periodicity for a default latency service. The default SR occasion periodicity may be associated with a defined QCI or 5QI. The default SR occasion periodicity may be associated with an eMBB bearer or an eMBB service. The RRC message may configure a short SR occasion periodicity for a low latency service. The low SR occasion periodicity may be associated with a defined QCI or 5QI. The short SR occasion periodicity may be associated with a low latency service. The RRC message may configure a long SR occasion periodicity for a high latency service. The long SR occasion periodicity may be associated with a defined QCI or 5QI. The long SR occasion periodicity may be associated with a deprioritized bearer or a deprioritized service.

As shown by reference number 604, the UE may receive application data from an upper layer of the UE. For example, the UE may have data that is available to be transmitted to the network node. As shown by reference number 606, the UE may determine whether the application data is associated with the low latency service. The UE may not make this determination when no data is available. As shown by reference number 608, when the application data is associated with the low latency service, the UE may use the short SR occasion periodicity for transmitting an SR to the network node. As shown by reference number 610, when the application data is not associated with the low latency service, the UE may determine whether the application data is associated with the high latency service. As shown by reference number 612, when the application data is associated with the high latency service, the UE may use the long SR occasion periodicity for transmitting the SR to the network node. As shown by reference number 614, when the application data is not associated with the high latency service, the UE may use the default SR occasion periodicity for transmitting the SR to the network node.

In some implementations, the UE may receive configurations for each of the default SR occasion periodicity, the short SR occasion periodicity, and the long SR occasion periodicity. Depending on the application that needs to be transmitted by the UE, the UE may determine which SR occasion periodicity to apply. For example, when the application is associated with the low latency service, the UE may determine to apply the short SR occasion periodicity, and so on.

As indicated above, FIG. 6 is provided as an example. Other examples may differ from what is described with regard to FIG. 6.

FIG. 7 is a diagram of an example environment 700 in which systems and/or methods described herein may be implemented. As shown in FIG. 7, environment 700 may include a UE 710, a network node 720, and a network 730. Devices of environment 700 may interconnect via wired connections, wireless connections, or a combination of wired and wireless connections.

The UE 710 may include one or more devices capable of receiving, generating, storing, processing, and/or providing information associated with service-based time periodicity values for SR occasions, as described elsewhere herein. The UE 710 may include a communication device and/or a computing device. For example, the UE 710 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network node 720 may include one or more devices capable of receiving, processing, storing, routing, and/or providing information associated with service-based time periodicity values for SR occasions, as described elsewhere herein. The network node 720 may be configured to communicate with the UE 710. The network node 720 may be an aggregated network node, meaning that the aggregated network node is configured to utilize a radio protocol stack that is physically or logically integrated within a single radio access network (RAN) node (e.g., within a single device or unit). The network node 720 may be a disaggregated network node (sometimes referred to as a disaggregated base station), meaning that the network node 720 is configured to utilize a protocol stack that is physically or logically distributed among two or more nodes (such as one or more central units (CUs), one or more distributed units (DUs), or one or more radio units (RUs)). The network node 720 may include, for example, an NR base station, a long-term evolution (LTE) base station, a Node B, an eNB (e.g., in 4G), a gNB (e.g., in 5G), an access point, a transmission reception point (TRP), a DU, an RU, a CU, a mobility element of a network, a core network node, a network element, a network equipment, and/or a RAN node.

The network 730 may include one or more wired and/or wireless networks. For example, the network 730 may include a cellular network (e.g., a 5G network, a fourth generation (4G) network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 730 enables communication among the devices of environment 700.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

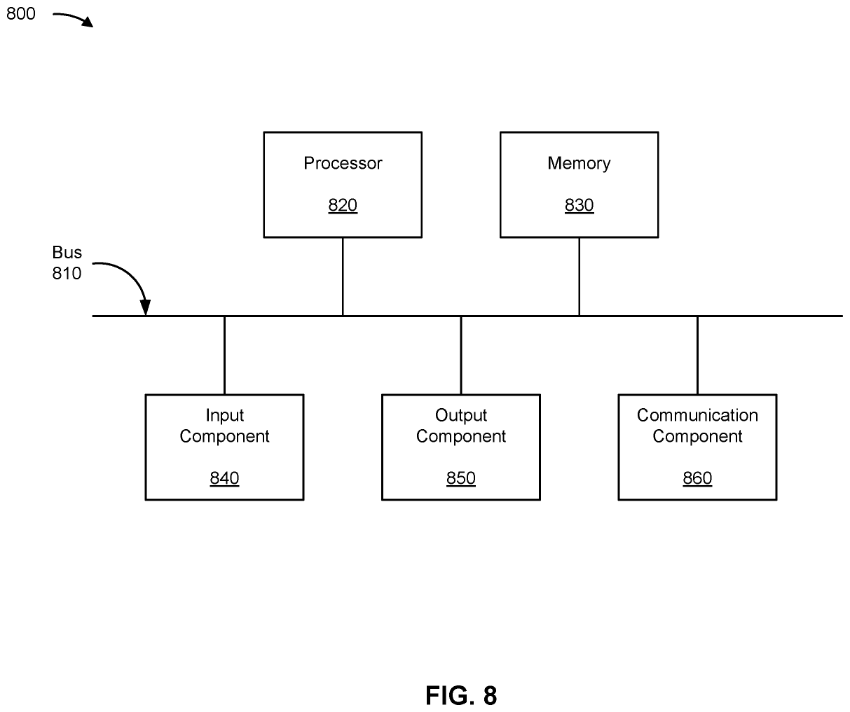

FIG. 8 is a diagram of example components of a device 800 associated with service-based time periodicity values for SR occasions. The device 800 may correspond to UE 710 and/or network node 720. In some implementations, UE 710 and/or network node 720 may include one or more devices 800 and/or one or more components of the device 800. As shown in FIG. 8, the device 800 may include a bus 810, a processor 820, a memory 830, an input component 840, an output component 850, and/or a communication component 860.

The bus 810 may include one or more components that enable wired and/or wireless communication among the components of the device 800. The bus 810 may couple together two or more components of FIG. 8, such as via operative coupling, communicative coupling, electronic coupling, and/or electric coupling. For example, the bus 810 may include an electrical connection (e.g., a wire, a trace, and/or a lead) and/or a wireless bus. The processor 820 may include a central processing unit, a graphics processing unit, a microprocessor, a controller, a microcontroller, a digital signal processor, a field-programmable gate array, an application-specific integrated circuit, and/or another type of processing component. The processor 820 may be implemented in hardware, firmware, or a combination of hardware and software. In some implementations, the processor 820 may include one or more processors capable of being programmed to perform one or more operations or processes described elsewhere herein.

The memory 830 may include volatile and/or nonvolatile memory. For example, the memory 830 may include random access memory (RAM), read only memory (ROM), a hard disk drive, and/or another type of memory (e.g., a flash memory, a magnetic memory, and/or an optical memory). The memory 830 may include internal memory (e.g., RAM, ROM, or a hard disk drive) and/or removable memory (e.g., removable via a universal serial bus connection). The memory 830 may be a non-transitory computer-readable medium. The memory 830 may store information, one or more instructions, and/or software (e.g., one or more software applications) related to the operation of the device 800. In some implementations, the memory 830 may include one or more memories that are coupled (e.g., communicatively coupled) to one or more processors (e.g., processor 820), such as via the bus 810. Communicative coupling between a processor 820 and a memory 830 may enable the processor 820 to read and/or process information stored in the memory 830 and/or to store information in the memory 830.

The input component 840 may enable the device 800 to receive input, such as user input and/or sensed input. For example, the input component 840 may include a touch screen, a keyboard, a keypad, a mouse, a button, a microphone, a switch, a sensor, a global positioning system sensor, an accelerometer, a gyroscope, and/or an actuator. The output component 850 may enable the device 800 to provide output, such as via a display, a speaker, and/or a light-emitting diode. The communication component 860 may enable the device 800 to communicate with other devices via a wired connection and/or a wireless connection. For example, the communication component 860 may include a receiver, a transmitter, a transceiver, a modem, a network interface card, and/or an antenna.

The device 800 may perform one or more operations or processes described herein. For example, a non-transitory computer-readable medium (e.g., memory 830) may store a set of instructions (e.g., one or more instructions or code) for execution by the processor 820. The processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry may be used instead of or in combination with the instructions to perform one or more operations or processes described herein. Additionally, or alternatively, the processor 820 may be configured to perform one or more operations or processes described herein. Thus, implementations described herein are not limited to any specific combination of hardware circuitry and software.

The number and arrangement of components shown in FIG. 8 are provided as an example. The device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

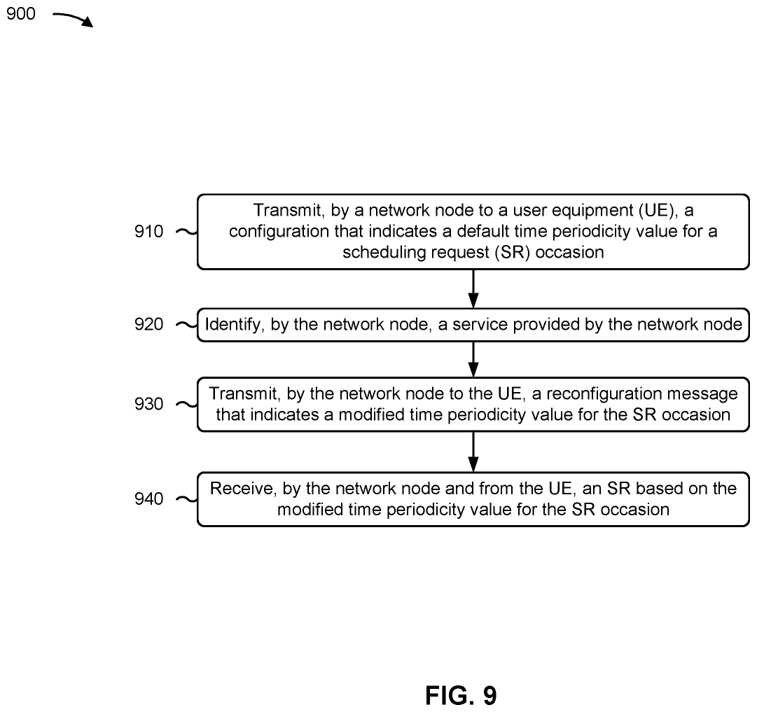

FIG. 9 is a flowchart of an example process 900 associated with indicating service-based time periodicity values for SR occasions. In some implementations, one or more process blocks of FIG. 9 may be performed by a network node (e.g., network node 720). In some implementations, one or more process blocks of FIG. 9 may be performed by another device or a group of devices separate from or including the network node, such as a UE (e.g., UE 710). Additionally, or alternatively, one or more process blocks of FIG. 9 may be performed by one or more components of device 800, such as processor 820, memory 830, input component 840, output component 850, and/or communication component 860.

As shown in FIG. 9, process 900 may include transmitting a configuration that indicates a default time periodicity value for an SR occasion (block 910). For example, the network node may transmit a configuration that indicates a default time periodicity value for an SR occasion, as described above. The process 900 includes monitoring a loading associated with an uplink channel, where the default time periodicity value is based on the loading associated with the uplink channel. The default time periodicity value may be associated with an eMBB service.

As further shown in FIG. 9, process 900 may include identifying a service provided by the network node (block 920). For example, the network node may identify a service provided by the network node, as described above. The service may be the eMBB service, a low latency service, or a deprioritized service.

As further shown in FIG. 9, process 900 may include transmitting a reconfiguration message that indicates a modified time periodicity value for the SR occasion, the modified time periodicity value being different than the default time periodicity value based on the service provided by the network node (block 930). For example, the network node may transmit a reconfiguration message that indicates a modified time periodicity value for the SR occasion, the modified time periodicity value being different than the default time periodicity value based on the service provided by the network node, as described above. The process 900 includes monitoring the loading associated with the uplink channel, where the modified time periodicity value is based on the loading associated with the uplink channel.

As further shown in FIG. 9, process 900 may include receiving, from the UE, an SR based on the modified time periodicity value for the SR occasion (block 940). For example, the network node may receive, from the UE, an SR based on the modified time periodicity value for the SR occasion, as described above.

In some implementations, the service may be the low latency service, and the modified time periodicity value may be less than the default time periodicity value based on the service being the low latency service. The process 900 includes determining that the low latency service has become disabled, where the configuration may be applied based on the low latency service becoming disabled. In some implementations, the service may be the deprioritized service, and the modified time periodicity value may be greater than the default time periodicity value based on the service being the deprioritized service. The process 900 includes determining that the deprioritized service has become disabled, where the configuration may be applied based on the deprioritized service becoming disabled.

In some implementations, the default time periodicity value for the SR occasion is associated with a frequency range (e.g., FR1 or FR2) and a loading associated with an uplink channel (e.g., a high loading or a normal loading associated with a PUCCH). The modified time periodicity value for the SR occasion is associated with a frequency range (e.g., FR1 or FR2) and a loading associated with an uplink channel (e.g., a high loading or a normal loading associated with a PUCCH).

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
transmitting, by a network node to a user equipment (UE), a configuration that indicates a default time periodicity value for a scheduling request (SR) occasion;
identifying, by the network node, a service provided by the network node;
transmitting, by the network node to the UE, a reconfiguration message that indicates a modified time periodicity value for the SR occasion, the modified time periodicity value being different than the default time periodicity value based on the service provided by the network node; and
receiving, by the network node and from the UE, an SR based on the modified time periodicity value for the SR occasion.

2. The method of claim 1, wherein the service is a low latency service, and wherein the modified time periodicity value is less than the default time periodicity value .

3. The method of claim 2, further comprising:
determining that the low latency service has become disabled, wherein the configuration is applied based on the low latency service becoming disabled.

4. The method of claim 1, wherein the service is a deprioritized service, and wherein the modified time periodicity value is greater than the default time periodicity value.

5. The method of claim 4, further comprising:
determining that the deprioritized service has become disabled, wherein the configuration is applied based on the deprioritized service becoming disabled.

6. The method of claim 1, wherein the default time periodicity value for the SR occasion is associated with a frequency range and a loading associated with an uplink channel.

7. The method of claim 1, wherein the modified time periodicity value for the SR occasion is associated with a frequency range and a loading associated with an uplink channel.

8. The method of claim 1, wherein the configuration that indicates the default time periodicity value for the SR occasion is associated with an enhanced mobile broadband (eMBB) service.

9. The method of claim 1, wherein the service is associated with a quality of service class identifier (QCI), and wherein the QCI is associated with a low latency service or a deprioritized service.

10. The method of claim 1, further comprising:
monitoring a loading associated with an uplink channel, wherein the default time periodicity value and the modified time periodicity value are based on the loading associated with the uplink channel.

11. A method, comprising:
receiving, by a user equipment (UE) and from a network node, a configuration that indicates a default time periodicity value for a scheduling request (SR) occasion;
receiving, by the UE and from the network node, a reconfiguration message that indicates a modified time periodicity value for the SR occasion, the modified time periodicity value being different than the default time periodicity value based on a service provided by the network node; and
transmitting, by the UE and to the network node, an SR based on the modified time periodicity value for the SR occasion.

12. The method of claim 11, wherein the service is a low latency service, and wherein the modified time periodicity value is less than the default time periodicity value .

13. The method of claim 11, wherein the service is a deprioritized service, and wherein the modified time periodicity value is greater than the default time periodicity value.

14. The method of claim 11, wherein the default time periodicity value for the SR occasion is associated with a frequency range and a loading associated with an uplink channel.

15. The method of claim 11, wherein the modified time periodicity value for the SR occasion is associated with a frequency range and a loading associated with an uplink channel.

16. The method of claim 11, wherein the configuration that indicates the default time periodicity value for the SR occasion is associated with an enhanced mobile broadband (eMBB) service.

17. The method of claim 11, wherein the service is associated with a quality of service class identifier (QCI), and wherein the QCI is associated with a low latency service or a deprioritized service.

18. A method, comprising:
receiving, by a user equipment (UE) and from a network node, a configuration that indicates a plurality of time periodicity values for scheduling request (SR) occasions;
detecting, by the UE, application data received from an upper layer of the UE;
determining, by the UE, a service associated with the application data;
selecting, by the UE, a time periodicity value for an SR occasion from the plurality of time periodicity values based on the service associated with the application data; and
transmitting, to the network node, an SR based on the time periodicity value for the SR occasion.

19. The method of claim 18, wherein the plurality of time periodicity values for the SR occasions includes:
a first time periodicity value associated with an enhanced mobile broadband (eMBB) service;
a second time periodicity value associated with a low latency service; and
a third time periodicity value associated with a deprioritized service.

20. The method of claim 18, wherein the configuration is a radio resource control (RRC) configuration or an RRC reconfiguration message.
